(19) United States
(12) Patent Application Publication
(10) Pub. No.: US 2004/0200359 A1
(43) Pub. Date: Oct. 14, 2004

(54) Outdoor cooker oven

(76) Inventor: Ronald B. Snider, New Braunfels, TX (US)

Correspondence Address: Charles W. Hanor, Gunn, Lee & Hanor, P.C., Suite 1500, 700 North St. Mary's Street, San Antonio, TX, 78205, US

(21) Appl. No.: 10/409,524

(22) Filed: Apr. 8, 2003

(51) Int. Cl. A47J 27/00

(52) U.S. Cl. 99/446; 99/448

(57) ABSTRACT

An outdoor oven and cooking method including a cooker formed from a base pan, housing and top pan and providing an enclosing cooking chamber. Combustible material is placed in the base pan around the outside of the chamber at the bottom and in the top pan at the top for heating and cooking food in the chamber. A food supporting rack for holding food is positioned inside the housing for cooking the food.

### BACKGROUND OF THE INVENTION

1. Field of the Invention

The invention relates to outdoor ovens and in particular to an oven that can be set and forgotten until the cooking is completed. Combustible material such as charcoal may be used around the bottom of the enclosed cooking chamber of the oven and at the top of the cooking chamber to accomplish the cooking.

The invention allows the cooking to be part of outdoor activities and allows the entire family to participate. Since there is essentially nothing to do after the cooking process is started, the outdoor activities can be enjoyed by the entire family.

2. Description of the Related Art

Outdoor cooking apparatuses are varied and numerous. They range from Dutch ovens to smokers to grills. Examples of Dutch ovens can be found at http://www.idos.com/index.html which is the web site for The International Dutch Oven Society and at http://www.dutchovencookware.com.

A type of outdoor cooker that can be used with a Dutch oven is shown in U.S. Pat. No. 4,909,235 and has a semi-conical outer housing and an inverted semi-conical firebox inserted therein. The firebox has a set of openings in its periphery towards the bottom portion thereof which the covered by a ring having similar openings which can be rotated to allow air to flow into the firebox or to prevent the flow of air into the firebox. The housing also has openings which allow air to flow into the area between the housing and the firebox. The interior of the firebox contains a fuel rack upon which fuel such as charcoal briquettes or the like may be placed and ignited. The stove can be covered with a grill upon which food may be cooked, or other utensils may be placed on the stove such as wok, a Dutch oven, a steamer, etc. Air flows through the housing and through the venting ring into the firebox where it is heated by the fuel, and then moves upwardly through the firebox to heat the food placed on a grill or in a cooking utensil located at the top opening of the firebox. Because of the distance between the fuel and the top opening of the firebox, food is substantially heated by the rising hot air, instead of by the radiant heat of the burning coals as in prior art devices.

U.S. Pat. No. 4,979,436 discloses a smoking and baking apparatus which is characterized by a cabinet having an outer shell and an inner shell that define a smoke channel there between. A firebox is located in the bottom of the cabinet and a pair of spaced flanges is positioned over the firebox for receiving a removable water pan. One or more doors close the cooking chamber of the cabinet, which cooking chamber is located above the firebox and is defined by the inner shell. A separate door closes the firebox and the water pan separates the firebox from the cooking chamber. A vertical duct or chimney is provided in the cabinet channel, which chimney opens to the smoking chamber at the lower end of the inner shell above the water pan and to the atmosphere at the upper end of the outer shell. When the water pan is resting on the spaced flanges over the firebox beneath the cooking chamber, smoke generated in the firebox is diverted by the water pan upwardly into the channel formed by the outer shell and the inner shell. The smoke then travels from the channel downwardly into the cooking chamber, across food located on removable shelves or trays in the cooking chamber and upwardly through the chimney to the atmosphere. Smoking and baking are effected in the cooking chamber of the apparatus when the water pan is in place, while barbequing and grilling may be accomplished with the water pan removed, wherein smoke and heat are introduced directly into the cooking chamber.

Design patent No 374,371 discloses a conventional smoker have a fire pan, drip pan, grill and cooker housing.

U.S. Pat. No. 4,430,985 discloses a charcoal cooker having a vessel having a lid providing for access to the interior of the vessel, a removable rack for supporting food during a cooking operation, a fire box adjustably disposed within the vessel and spaced below the rack for supplying heat during the cooking operation, and thermostatically actuated valves provided for the vessel and responsive to the internal temperatures in the cooker for alternately opening and closing to automatically maintain a preselected temperature within the vessel during an entire cooking operation.

U.S. Pat. No. 5,359,923 discloses a combination smoker and cooker having adjustably spaced grills so as to make easier access to the grills and to replenish cooking fuel. The cooker has a grill support bar for supporting multiple grills including a water pan steamer assembly, at adjustable vertically spaced intervals in housing. The grill support bar has pairs of vertically spaced slots cut into oppositely facing sides thereof and is held in the housing by a socket which is sized and shaped to firmly receive a bottom end of the support bar and secure the support bar in place in the cooker.

U.S. Pat. No. 5,195,423 discloses a two-part smoker assembly having a slide-detachable fire chamber engageable to a separable smoking chamber, the latter capable of being mountably rested atop the firebox walls of a grill. The slide-detachable smoking chamber has front and rear access doors, a side opening for side-attaching the fire chamber thereto, a top-opening for mounting a cover lid thereon, and food racks for supporting food materials within the smoking chamber. Within the smoking chamber, rack supports for the food racks are provided for adjusting the food racks to various levels. The cover is hinged and consists of a central piano hinge, which divides the cover lid into two openable halves and allows access to the food racks from the top front or top rear of the assembly. The slide-detachable fire chamber includes a stoking door to facilitate loading a fuel source, such as, wood, a gas assist apparatus, a bottom ash pit, an ash door for holding and emptying ashes, draft dampers,

### BRIEF SUMMARY OF THE INVENTION

A cooker is provider having a base pan means for supporting a food product for cooking and holding combustible material for heating and cooking. A cooking housing is positioned on the base pan to cover a bottom opening on the cooking housing for forming an oven with the combustible material for heating on the outside of the cooking housing and a food support rack for holding food is positioned inside the housing. A top pan covers the top opening of the cooking housing and holds combustible material outside of the cooking housing to form an enclosed cooking chamber for further heating the inside of the cooking housing and cooking chamber. The cooking housing may include vent holes to allow the escape of gases and a drip pan is positioned on the base pan for catching drippings from the food. The cooking housing has a truncated conical shape with the larger portion at the bottom for setting on the base pan. A removable support base is provided for the base pan means.

Cooking is accomplished by igniting combustible material on the base pan and outside the cooking housing positioned on the base pan for heating on the outside of the cooking housing for cooking the food on a food support rack inside the housing. The top of the cook housing is covered with the top pan holding additional combustible material outside of the cooking housing for further heating the inside of the cooking housing and cooking chamber.

The cooker is sized to provide sufficient amount of cooking to food inside the house once the charcoal is ignited so that the cooker will cook unattended until finished.

### BRIEF DESCRIPTION OF THE SEVERAL VIEWS OF THE DRAWINGS

FIG. 1 is a perspective view of a version of an assembled cooker.

FIG. 2 is an exploded view showing the parts of the cooker.

FIG. 3 is a perspective view of a version of an assembled cooker with the food rack shown in hidden lines and the top removed.

FIG. 4 is a partial cross sectional view showing the detail of the base pan.

FIG. 5 is a perspective view of an alternative version of the food cooking rack or

FIG. 6 is a perspective view of an alternative version of the food cooking rack or

FIG. 7 is a perspective view of an alternative version of the food cooking rack or

FIG. 8 is a perspective view of an alternative version of the food cooking rack or basket shown in the cooker.

FIG. 9 is a perspective view of an alternative version of the food cooking rack or basket.

FIG. 10 is a perspective view of an alternative version of the food cooking rack or basket.

FIG. 11 is a perspective view of a handle and hook for some alternative versions of the food cooking rack or basket.

FIG. 12 is a cross sectional view of an alternative version of an assembled cooker.

### DETAILED DESCRIPTION OF THE INVENTION

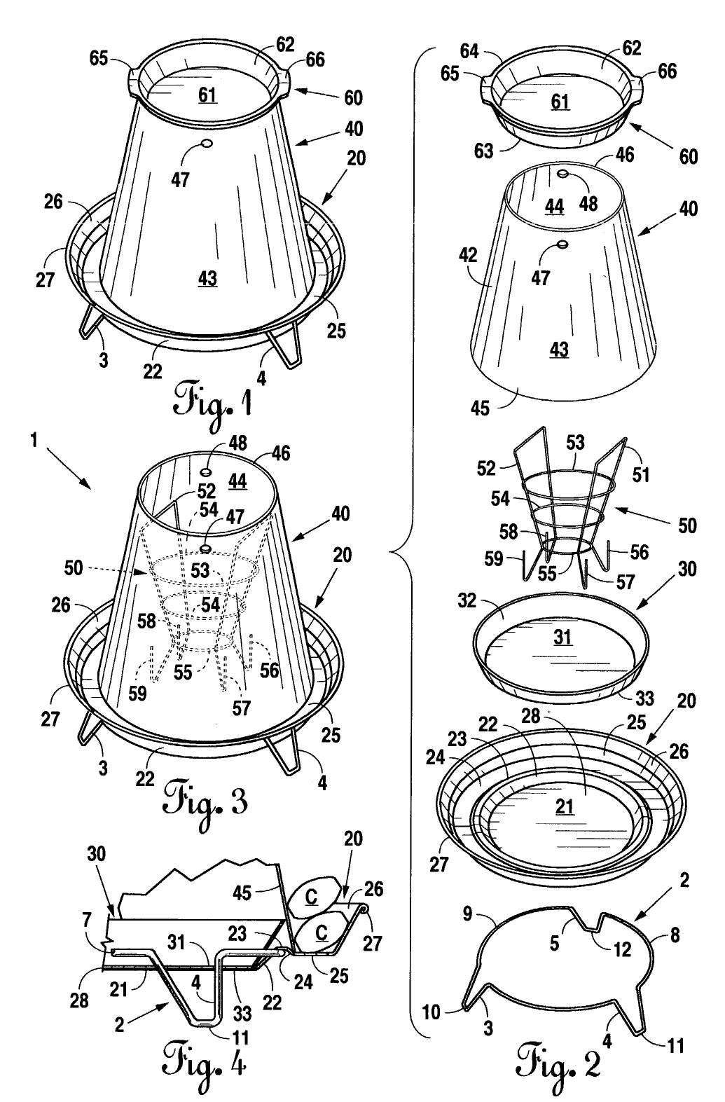

Referring to FIGS. 1, 2 and 3, there is shown a cooker means 1 that is assembled for cooking. The cooker 1 may include a circular wire support base means 2 having support legs 3, 4 and 5 and support members 7, 8,& 9 that are designed to engage the base pan 20. The legs 3, 4 & 5 include horizontally extending ground engaging portions 10, 11 & 12 that are straight and engage the ground to support the cooker and space the hot portion of the cooker from the ground. Alternatively, separate support legs of heat resistant material such as metal may be secured to the pan 21 by standard means such as spot welding.

The base pan means 20 includes a circular bottom flat portion 21 for supporting the drip pan 30. The flat portion 21 is formed with an upwardly and outwardly inclined circular portion 22 that is similarly formed with a circular horizontal portion 23. The horizontal portion 23 is formed with a downwardly and outwardly extending portion 24 so that the portion 23 engages the support members 7, 8 & 9. The outwardly extending portion 24 is formed with a circular horizontally extending portion 25 that supports the charcoal C. The horizontally extending portion 25 is formed with an upwardly and outwardly extending portion 26 that terminates in a rolled edge 27 to form the pan 20.

The drip pan means 30 has a flat circular base 31 and an upwardly and outwardly extending side wall 32 to help with the cooking. The lower surface 33 of the drip pan is designed to rest on the upper surface 28 of the base pan 20. The diameter of the base 31 is slightly less than the diameter of the flat portion 21 so that it will rest on the flat portion 21 as shown in FIG. 4.

A truncated conical cooking housing means 40 includes and inwardly inclined vertical wall 42 and outer surface 43, inner surface 44, lower edge 45 and upper edge 46. The lower edge 45 is designed to engage the portion 25 of the base pan 20 as shown in FIG. 4. The diameter of the lower edge 45 is sufficient so that it engages the junction between the portions 24 and 25 of the base pan 20. Small circular holes 47 and 48, approximately 0.125 inches, may be provided at the top portion of the housing 40 as shown in FIGS. 1 and 2 to vent the steam out of the housing cooking. Hinged or sliding door means may be provided to cover and uncover the vent holes 47 and 48 as desired during cooking. A simple cover means for covering the vent holes could be a circular disk pivotally secured to the housing 40 so that the cover means could be pivoted between opened and closed positions to control venting from the housing 40 during cooking.

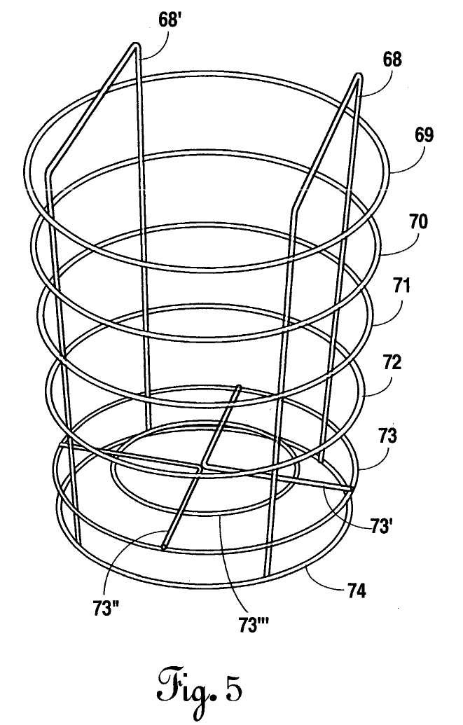

A truncated conical food cooking rack means 50, as shown in FIGS. 2 and 3, includes inverted U-shaped leg members 51 and 52 that are connected by circular rings 53, 54 and 55 by suitable means such as welding. The leg members 51 and 52 sit on the upper surface of the drip pan 30 and support the food being cooked in the cooker 1. The ends 56, 57, 58 and 59 of the leg members 51 and 52 are bent upwardly and serve as a skewer for food such as meat, potatoes or corn. The rack is sized to position the food a proper distance from the bottom of the pan 31, FIGS. 2 and 4, and charcoal around the periphery of the housing 40 and not burn the food in the rack.

An alternative food cooking rack or basket means 67 is shown in FIG. 5 and includes inverted U-shaped leg members 68 and 68′ that are connected to ring members 69, 70, 71, 72, 73 and 74 by suitable means such as welding. V-shaped cross bar members 73′ and 73″ are connected to each other at their apexes and to ring 73′″ to form a food support. Inner ring 73′″ is connected to the members 73′ and 73″ to help retain food in the basket. The rack is sized to position the food a proper distance from the bottom of the pan 31, FIGS. 2 and 4, and charcoal around the periphery of the housing 40 and not burn the food in the rack.

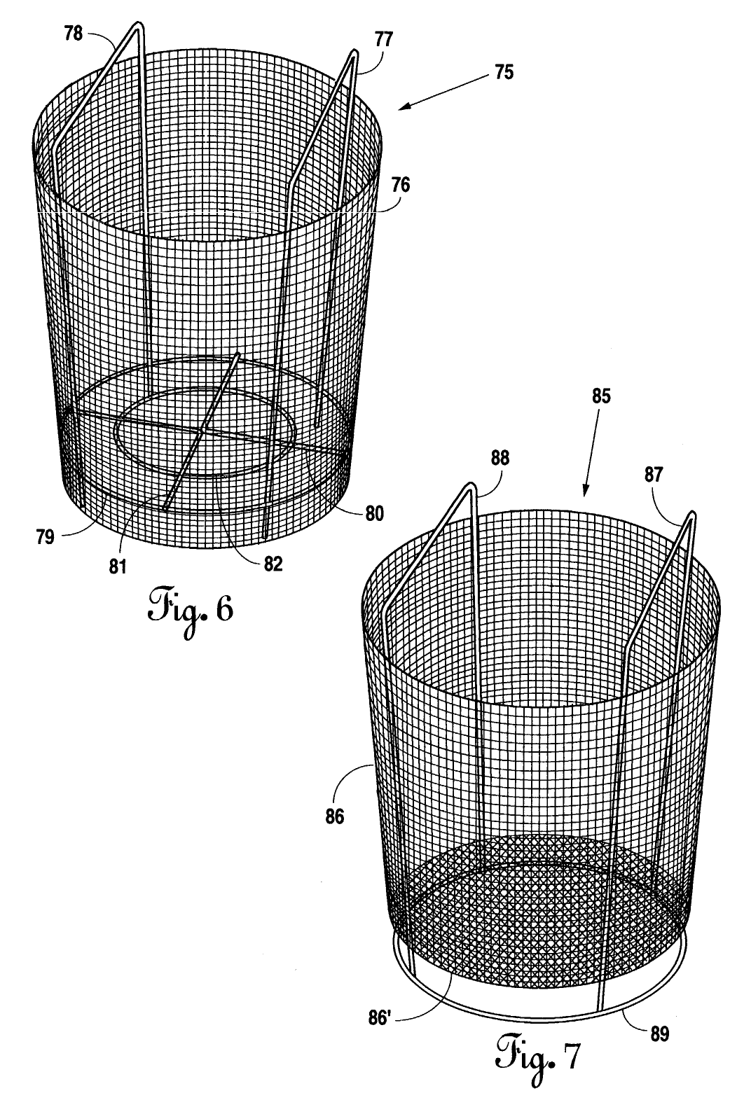

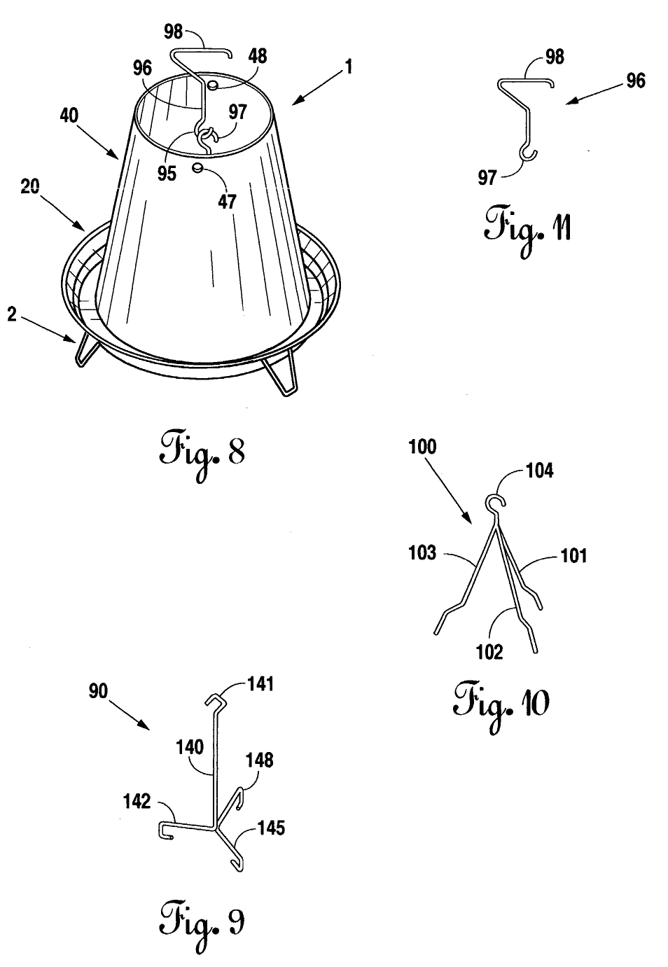

Another alternative food cooking rack or basket means 75 is shown in FIG. 6 and includes a wire mesh cylindrical member 76. Secured to the basket 75 are inverted U-shaped leg members 77 and 78 that are connected to ring member 79 by suitable means such as welding. V-shaped cross bar members 80 and 81 are connected to each other at their apexes and to ring 79 to form a food support. Inner ring 82 is connected to the members 80 and 81 to help retain food in the basket. The rack is sized to position the food a proper distance from the bottom of the pan 31, FIGS. 2 and 4, and charcoal around the periphery of the housing 40 and not burn the food in the rack.

Another alternative food cooking rack or basket means 85 is shown in FIG. 8 and includes a wire mesh cylindrical member 86. Secured to the basket 85 are inverted U-shaped leg members 87 and 88 that are connected to ring member 89 by suitable means such as welding. A flat wire mesh bottom member 89′ is secured to the lower edge of the basket 85 to retain food in the basket. The rack is sized to position the food a proper distance from the bottom of the pan 31, FIGS. 2 and 4, and charcoal around the periphery of the housing 40 and not burn the food in the rack.

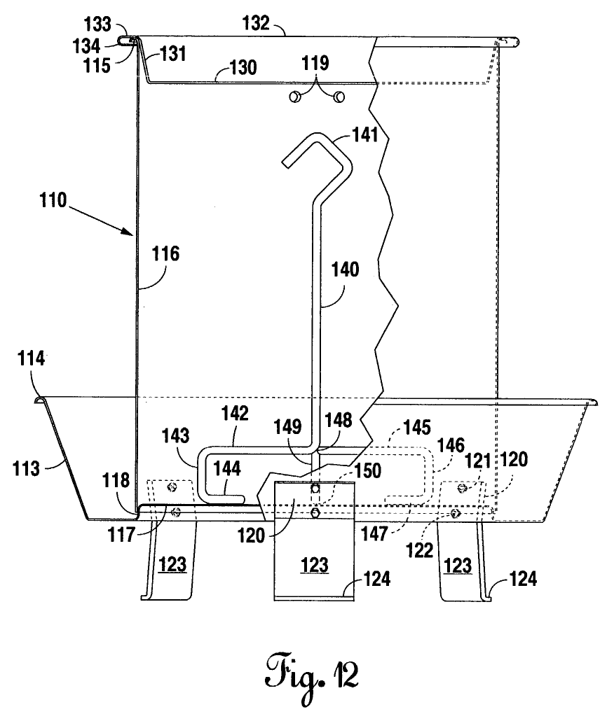

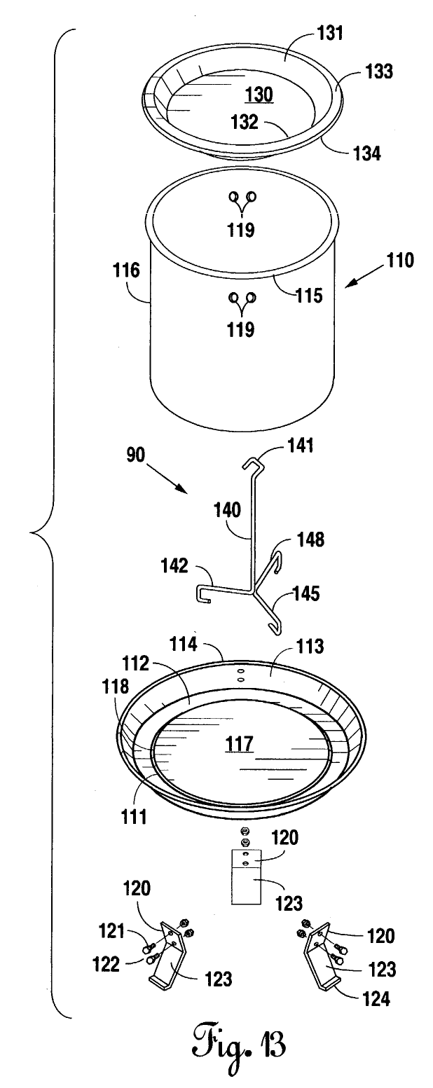

Another alternative food cooking rack means 90, as shown in FIGS. 8, 9, 12 and 13, includes a vertical food support means having leg members 142, 145 and 148 that are connected to upright support member 140 that terminates in an upper hook member 141. The leg members 142, 145 and 148 sit on the upper surface of the drip pan 30, FIG. 2 and include foot members 143, 146 and 149 with shoe members 144, 147 and 150 and support the food being cooked in the cooker 1. As shown in FIG. 11, a retrieval handle means 96 is provided with a hook 97 at in lower end and a handle member 98 at its upper end. The rack is sized to position the food a proper distance from the bottom of the pan 31, FIGS. 2 and 4, and charcoal around the periphery of the housing 40 and not burn the food on the rack. The rack is also sized to position the food a proper distance from the bottom of the pan 117, FIGS. 12 and 13, and charcoal around the periphery of the housing 110 and not burn the food on the rack. The retrieval handle means 96 allows removal of the rack 90 and any food being cooked from the cooker.

Another alternative food cooking rack means 100, as shown in FIG. 10, includes a vertical food support means having leg members 101, 102 and 103 that are connected at their upper ends to an upper hook member 104. The leg members 101, 102 and 1033 sit on the upper surface of the drip pan 30, FIG. 2 and support the food being cooked in the cooker 1. As shown in FIG. 11, the retrieval hook 96 is provided with a hook 97 at in lower end and a handle member 98 at its upper end. The rack is sized to position the food a proper distance from the bottom of the pan 31, FIGS. 2 and 4, and charcoal around the periphery of the housing 40 and not burn the food in the rack. The retrieval hook 96 allows removal of the rack 100 and any food being cooked from the cooker.

The top cook pan 60 has a flat circular base 61 and an upwardly and outwardly extending cylindrical side wall 62 to cover the top of the housing 40 and help with the cooking. The lower surface 63 of the lip 64 of the top cook pan 60 is designed to rest on the upper edge 46 of the housing 40. The larger diameter of the circularly wall 62 is slightly less than the inner diameter of the upper portion of the housing 42 so that it will rest on the edge 46 and seal the upper open end of the housing as shown in FIGS. 1 and 2. Handle extensions 65 and 66 are provided to hold the pan 60.

A simplified alternative version of the cooker is shown in FIGS. 12 and 13. The cooker includes a metal cylindrical housing means 110 having a cylindrical vertical wall 116 with an upper lip member 115. A plurality of vent holes 119 are provided to release gases from the housing.

A base pan means includes a flat raised portion 117 with a downwardly sloped wall 118 connecting with a recessed flat portion 112. The flat portion 112 connects with the upwardly and outwardly wall portion 113 that terminates in a lip member 114. The lower edge of the housing 110 rests on the edge of the wall 118 as shown in FIG. 12. A drip pan means such as drip pan 30 shown in FIG. 2 may be positioned on the base pan mean as shown in FIG. 4.

Secured to the base pan means are three removable legs 123 having foot portions 124 and attaching portions 120. Two holes are provided in each attaching portion 120 and bolts 121 and 122 attached each leg to the base pan means through two mating holes in the base pan means as shown in FIGS. 12 and 13.

A circular top cover means 130 covers the top of the housing 110 during cooking and serves a container for the upper layer of cooking charcoal. The top cover means 130 has a truncated conical shape with an outwardly inclined wall portion 131. A support lip portion 133 extends from the upper edge of the wall portion 131 and ends in a curved portion 134 as shown in FIG. 12. The lip portion 133 rests on the upper lip member 115 of the housing means 110.

The operation of the cooker 1 is a follows. Water or other liquid may optionally be poured into the drip pan 20. When water is used in the drip pan 20, the cooker 1 also acts as a steamer for vegetables or seafood. The food rack 10 is set on the drip pan 20 with the food being cooked positioned above the bottom of the pan 20. Charcoal C is placed around the periphery of the cook 20 resting on the portion 25 as shown in FIG. 4. Charcoal may also be placed in the top cook pan 60 and the cooker is assembled as shown in FIG. 1. The charcoal C is lighted at the bottom and top and then the food is allowed to cook. Because the diameter of the edge 45 is greater than the diameter of the edge 46, the food is heated more uniformly since the housing in contact with the charcoal would be the hottest temperature. The charcoal would heat the housing 40 and the heat would radiant inwardly to cook the food.

The cooker 1 is sized so that using a standard amount of charcoal will typically heat the cooker for an adequate period of time to fully cook food on the rack 50 without adding additional charcoal during cooking. The height of the wall 26 on the base pan, approximately 3.63 inches, and the width of circular portion 25, approximately 2 inches, allows a sufficient amount of charcoal to be placed around the housing 40. The height of the wall 62, approximately 1 inch, similarly allows a sufficient amount of charcoal to be placed at the top of the cooker. The charcoal used is sufficient to allow the cooker 1 to operate about 2.25 to 2.5 hours with one charge of charcoal. Charcoal is preferred because it provides a predetermined amount of cooking time. With a typical charcoal grill, the charcoal is started and cooking of the food is not commenced until the starter fluid and charcoal have burned for period and becomes hot enough to provide cooking. The initial flavors of the starting fluid and charcoal are such that one must wait until the charcoal is fully ignited before putting the food on the grill for cooking. With the cooker 1, cooking commences shortly after lighting the charcoal and continues until the charcoal burns out because the charcoal is outside the cooking chamber and does not contaminate the food with undesirable flavors.

The housing 40 is sized with a height of approximately 15 inches and sufficient diameter at edge 45, approximately 12 inches and edge 46, 10 inches, to provide a properly sized cooking chamber for the amount of charcoal in a single charge. The dimensions of the cooker 1 can be varied as long as it retains the functionality and cooking characteristic set forth herein.

The cooker allows you to cook outdoors without any kitchen mess. The cooker typically does not expose the food to charcoal and lighter fluid or any other possible contaminants. Wood chips may be placed inside the housing 40 adjacent the edge 45 to provide cooking flavor to the food being cooked. The cooker is sized to cook a 12-14 pound poultry in about 2.25 and 2.5 hours, the burn time of the charcoal, without any attention during cooking. The normal cook time of charcoal is sufficient to fully cook a turkey without any attention because of the size of the cooker. Other combustible materials could be used and would preferably have similar burn characteristics of charcoal. Temperatures at the outside of the housing 40 were measured to be about 450 degrees F. at the top and about 300 degrees F. at the bottom. The amount of charcoal at the bottom of the cooker can be varied when different types and weights of food are cooked. The time of burning of the charcoal, once ignited, is approximately the same with small and larger amounts of charcoal so the amount of charcoal is proportional to the amount of heat supplied to the food in the cooker during the cooking cycle.

We claim:

1. A cooker, comprising:
a base pan means for supporting a food product for cooking and combustible material for heating and cooking;
a cooking housing means for positioning on the base pan to cover a bottom opening on the cooking housing for forming an oven with the combustible material for heating on the outside of the cooking housing;
a food support rack means for supporting food inside the housing; and
a top pan means for covering the top opening of the cooking housing and for holding additional combustible material outside of the cooking housing to form an enclosed cooking chamber for further heating the inside of the cooking housing and cooking chamber whereby the cooker is sized to cook a food item with one charge of combustible material around the cooking housing means and the top pan means.

2. The cooker of claim 1, wherein:
vent opening means are provided in the housing to allow the escape of gases.

3. The cooker of claim 1, wherein:
a drip pan means is positioned on the base pan for catching drippings from the food.

4. The cooker of claim 1, wherein:
the cooking housing means has a truncated conical shape with the larger portion at the bottom.

5. The cooker of claim 1, wherein:
the base pan means includes a removable support base means.

6. The cooker of claim 1, wherein:
the base pan means includes an inverted truncated food holding means.

7. The cooker of claim 1, wherein:
the food support rack means includes a wire basket means.

8. The cooker of claim 1, wherein:
the food support rack means includes a wire mesh basket.

9. The cooker of claim 1, wherein:
the food support rack means includes a vertical food support means with three support legs.

10. The cooker of claim 1, wherein:
the food support rack means includes a retrieval handle means for inserting and removing the vertical food support means.

11. A cooker, comprising:
a base pan means for supporting a food product for cooking and combustible material for heating and cooking;
a cooking housing means having a truncated conical shape with the larger portion at the bottom for positioning on the base pan to cover a bottom opening on the cooking housing for forming an oven with the combustible material for heating on the outside of the cooking housing and the food;
the cooking housing includes vent holes to allow the escape of gases:
a drip pan means positioned on the base pan for catching drippings from the food;
a food support rack means for holding food inside the housing; and
a top pan means for covering a top opening of the cooking housing and for holding additional combustible material outside of the cooking housing to form an enclosed cooking chamber for further heating the inside of the cooking housing and cooking chamber whereby the cooker is sized to cook a food item with one charge of combustible material.

12. A method of cooking food products, comprising the steps of:
positioning food on a food support rack means inside a cooking housing means having a base pan means which covers the bottom opening on the cooking housing means;
covering the top opening of the cooking housing with a top pan means to form an enclosed cooking chamber;
igniting combustible material on the base pan means and the top pan means and outside the cooking housing positioned on the base pan means and with the combustible material for heating on the outside of the cooking housing for cooking the food on the food support rack inside the housing and whereby the cooker is sized to cook a food item with one charge of combustible material.

13. The method of claim 7, including the step of:
venting gases from inside the oven during cooking.
